(19) United States
(12) Patent Application Publication
(10) Pub. No.: US 2006/0268899 A1
(43) Pub. Date: Nov. 30, 2006

(54) INTERLOCK SYSTEM FOR HOME NETWORK AND TELEMATICS SYSTEM USING WIBRO NETWORK, AND CONTROL METHOD THEREOF

(76) Inventor: JUNG HYUN LIM, Icheon-shi (KR)

Correspondence Address: IPLA P.A., 3580 WILSHIRE BLVD., 17TH FLOOR, LOS ANGELES, CA, 90010, US

(21) Appl. No.: 11/308,044

(22) Filed: Mar. 3, 2006

(30) Foreign Application Priority Data
Apr. 29, 2005 (KR) 10-2005-0036218

(51) Int. Cl. H04L 12/56

(52) U.S. Cl. 370/401

(57) ABSTRACT

An interlock system for a home network and a telematics system and a control method thereof are provided. The interlock system includes an information center for storing and managing image information and data; a telematics unit for collecting the image information and data for a telematics service, receiving a control signal from the information center through interface with the information center, and transmitting a control signal generated according to a user's request to the information center; and a home network gateway for interfacing information generated from the telematics unit or the information center, with a home network.

### BACKGROUND OF THE INVENTION

1. Field of the Invention

The present invention relates to an interlock system for a home network and a telematics system and a control method thereof, and more particularly, to a system and method for interlocking a home network and a telematics system using Wireless Broadband Internet (WiBro) network.

2. Description of the Related Art

Telematics system detects occurrence of vehicle accident or theft, guides a vehicle running path, and provides a vehicle driver with a variety of other information, using a mobile communication method associated with a position tracing method. In other words, the telematics system provides information through a vehicle based on a Global Positioning System (GPS) using a mobile communication system and a GPS satellite. Accordingly, the telematics system can provide a variety of mobile communication services, such as traffic information, countermeasure to an emergency situation, remote vehicle diagnosis, the use of Internet (for example, financial transaction, provision of news, and transmission and reception of e-mail), using the GPS, a wireless communication network and an Internet network.

Meantime, in general, a mobile communication terminal is being now spread and accordingly, a research for various functions for improving a user convenience of the mobile communication terminal is being actively progressed. Further, a Wireless Broadband Internet (WiBro) network and a home network are being also actively researched and accordingly, a system for interlocking the telematics system, and the WiBro network and the home network is being required.

### SUMMARY OF THE INVENTION

Accordingly, the present invention is directed to an interlock system for a home network and a telematics system using a WiBro network and a control method thereof that substantially overcome one or more of the limitations and disadvantages of the conventional art.

One object of the present invention is to provide a system and method for interlocking a home network and a telematics system using a WiBro network.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for interlocking a home network and a telematics system using a WiBro (Wireless Broadband Internet) network, the system including: an information center for storing and managing image information and data; a telematics unit for collecting the image information and data for a telematics service, receiving a control signal from the information center through interface with the information center, and transmitting a control signal generated according to a user's request to the information center; and a home network gateway for interfacing information generated from the telematics unit or the information center, with a home network.

In another aspect of the present invention, there is provided a control method of a system for interlocking a home network and a telematics system using a WiBro (Wireless Broadband Internet) network, the method including the steps of: in an information center, storing and managing image information and data; in a telematics unit, collecting the image information and data for a telematics service, receiving a control signal from the information center through interface with the information center, and transmitting a control signal generated according to a user's request to the information center; and in a home network gateway, interfacing information generated from the telematics unit or the information center, with a home network.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 schematically illustrates a construction of a system interlocking a home network and a telematics system using a WiBro network according to an embodiment of the present invention;

FIG. 2 illustrates a construction of a telematics unit of FIG. 1; and

FIG. 3 illustrates a construction of a home network gateway of FIG. 1.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides a system and method for interlocking a home network and a telematics system using a WiBro network.

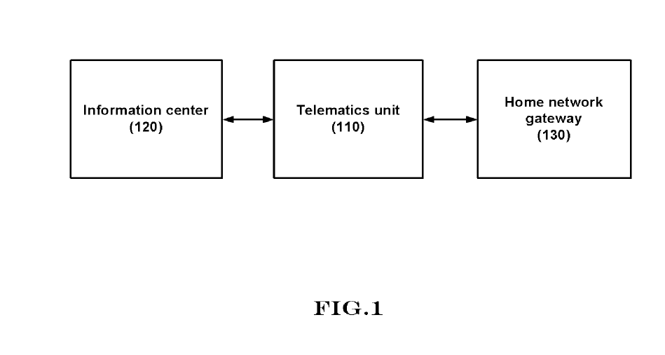

FIG. 1 schematically illustrates a construction of a system interlocking a home network and a telematics system using a WiBro network according to an embodiment of the present invention.

Referring to FIG. 1, the inventive interlock system includes an information center 110, a telematics unit 120, and a home network gateway 130.

The information center 110 stores and manages image information and data. The telematics unit 120 collects the image information and data for a telematics service, receives a control signal from the information center 110 through interface with the information center 110, and transmits a control signal generated depending on user's request, to the information center 110. The home network gateway 130 interfaces information generated from the telematics unit 120 or the information center 110, with the home network.

The inventive interlock system provides an emergency rescue service, a method service, a home appliances control service, a position confirmation service, and a monitoring service. The emergency rescue service, the method service, the home appliances control service, the position confirmation service, and the monitoring service will be described below.

First, in the emergency rescue service, upon generation of an emergency circumstance at a home or a vehicle, information is collected in the information center 110 and a service scenario is performed.

Second, in the method service, a service can be provided through a home camera installed at the home. Upon generation of a problem, a communication is performed with the vehicle or a mobile communication terminal, and a service scenario is performed.

Third, in the home appliances control service, a service scenario is performed to transmit a control request inputted through the vehicle or the mobile communication terminal, to the home network gateway 130 installed at the home, and control home appliances.

Fourth, in the position confirmation service, a service scenario is performed to search for an accurate position of the vehicle at the home, using a global positioning system (GPS) installed at the vehicle.

Fifth, in the monitoring service, a service scenario is performed to monitor a home circumstance through the home camera, even at the vehicle.

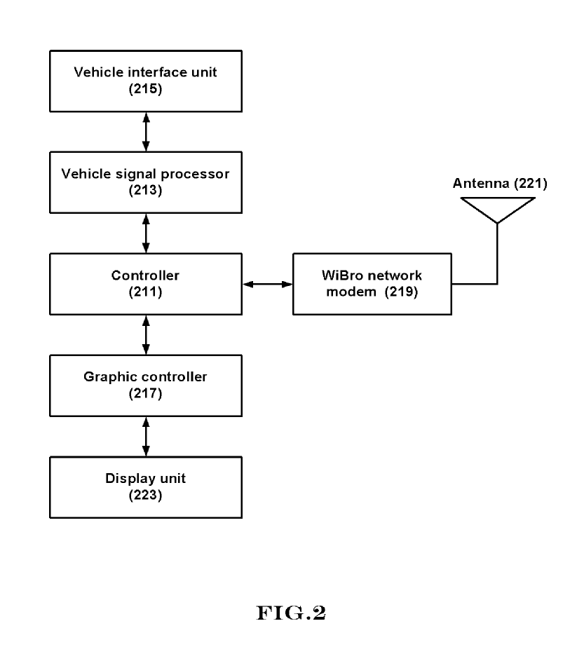

In FIG. 1, the construction of the system for interlocking the home network and the telematics system using the WiBro network according to an embodiment of the present invention is described and, with reference to FIG. 2, a construction of the telematics unit 120 will be described below.

FIG. 2 illustrates the construction of the telematics unit of FIG. 1.

Referring to FIG. 2, the telematics unit 120 includes a controller 211, a vehicle signal processor 213, a vehicle interface unit 215, a graphic controller 217, a WiBro network modem 219, an antenna 221, and a display unit 223.

First, the WiBro network modem 219 performs a wireless data communication between the telematics unit 120 and the information center 110. In other words, the WiBro network modem 219 uploads a user's command from the telematics unit 120 to the information center 110, and downloads data from the information center 110 to the telematics unit 120.

The graphic controller 217 controls a necessary screen of the display unit 223 for a user interface, and allows a user of the telematics unit 120 to confirm whether or not an operation based on the user's command is normally performed through the display unit 223. The data downloaded from the information center 110 is displayed on the display unit 223 under the control of the graphic controller 217.

The controller 211 controls a general operation of the telematics unit 120, processes data or image information downloaded from the information center 110, and performs a direct command of processing the user's command inputted to the telematics unit 120 and uploading the processed user's command to the information center 110. The vehicle interface unit 215 interfaces a vehicle state or the command transmitted from the telematics system to the vehicle, with the vehicle. The vehicle signal processor 213 receives the vehicle state from the vehicle through the vehicle interface unit 215, analyzes the received vehicle state, and transmits the analyzed vehicle state to the controller 211 and accordingly, the controller 211 uploads the vehicle state to the information center 110.

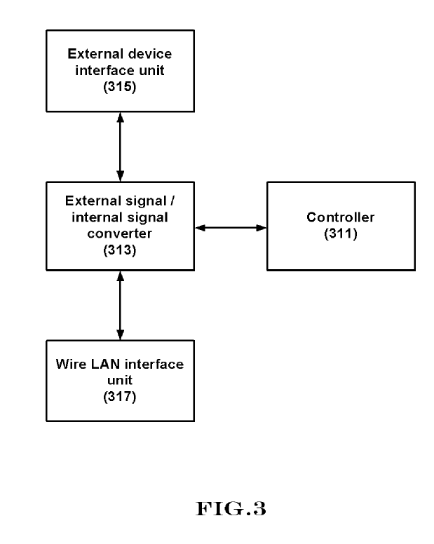

In FIG. 2, the construction of the telematics unit 1120 of FIG. 1 is described and, with reference to FIG. 3, a construction of the home network gateway 130 of FIG. 1 will be described below.

FIG. 3 illustrates the construction of the home network gateway 130 of FIG. 1.

Referring to FIG. 3, the home network gateway 130 includes a controller 311, an external signal/internal signal converter 313, an external device interface unit 315, and a wire local area network (LAN) interface unit 317.

The controller 311 controls conversion of a signal received through an external LAN through the wire LAN interface unit 317. The wire LAN interface unit 317 downloads data from the information center, or uploads data to the information center 110. The external signal/internal signal converter 313 converts the signal received from the external, into a signal capable of being used in the home network gateway 130. The external device interface unit 315 interfaces the home network gateway 130 and an external device.

As described above, the present invention has an advantage of interlocking the home network and the telematics system using the WiBro network, thereby increasing a user convenience.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A system for interlocking a home network and a telematics system using a WiBro (Wireless Broadband Internet) network, the system comprising:
an information center for storing and managing image information and data;
a telematics unit for collecting the image information and data for a telematics service, receiving a control signal from the information center through interface with the information center, and transmitting a control signal generated according to a user's request to the information center; and
a home network gateway for interfacing information generated from the telematics unit or the information center, with a home network.

2. The system according to claim 1, wherein the telematics unit comprises:
a WiBro network modem for performing a wireless data communication between the telematics unit and the information center under a predetermined control;
a controller for processing data or image information downloaded from the information center, and performing a direct command of processing and uploading an inputted user's command to the information center;
a display unit for displaying the inputted user's command and the downloaded data or image information under a predetermined control;
a graphic controller for controlling to display the inputted user's command and the downloaded data or image information on the display unit;
a vehicle interface unit for interfacing a vehicle state or a command transmitted from the telematics system to a vehicle, with the vehicle; and
a vehicle signal processor for analyzing the vehicle state transmitted through the vehicle interface unit.

3. The system according to claim 1, wherein the home network gateway comprises:
a wire LAN interface unit for downloading data from the information center or uploading data to the information center;
a controller for controlling conversion of a signal received through an external LAN through the wire LAN interface unit;
an external signal/internal signal converter for converting a signal inputted from an external device, into a signal used in the home network gateway; and
an external device interface unit for interfacing the home network gateway and the external device.

4. A control method of a system for interlocking a home network and a telematics system using a WiBro (Wireless Broadband Internet) network, the method comprising the steps of:
in an information center, storing and managing image information and data;
in a telematics unit, collecting the image information and data for a telematics service, receiving a control signal from the information center through interface with the information center, and transmitting a control signal generated according to a user's request to the information center; and
in a home network gateway, interfacing information generated from the telematics unit or the information center, with a home network.
